(19) United States
(12) Patent Application Publication
(10) Pub. No.: US 2003/0227846 A1
(43) Pub. Date: Dec. 11, 2003

(54) Recording medium for storing write protection information, and recording method and write protection method thereof

(75) Inventors: Kyung-Geun Lee, Gyeonggi-do (KR); In-Sik Park, Gyeonggi-do (KR); Jung-Wan Ko, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/443,097

(22) Filed: May 22, 2003

(30) Foreign Application Priority Data
Jun. 7, 2002 (KR) 2002-31995

(51) Int. Cl. G11B 7/00

(52) U.S. Cl. 369/53.21; 369/275.3; 369/94

(57) ABSTRACT

A multi-layer recording medium for storing write protection information, and a recording method and a write protection method thereof. The multi-layer optical recording medium includes a plurality of writable or rewritable recording layers, each of which includes a lead-in zone, a lead-out zone, and a data zone. The multi-layer optical recording medium stores write protection information for selectively protecting data recorded on the multi-layer recording medium from overwriting.

### CROSS-REFERENCE TO RELATED APPLICATIONS

This application claims the benefit of Korean Patent Application No. 2002-31995, filed on Jun. 7, 2002 in the Korean Intellectual Property Office, the disclosure of which is incorporated herein in its entirety by reference.

### BACKGROUND OF THE INVENTION

1. Field of the Invention

The present invention relates to a multi-layer recording medium which includes a plurality of recording layers and stores write protection information necessary to prevent recording, a method of recording write protection information, and a write protection method thereof.

2. Description of the Related Art

Optical disc techniques widely used in the field of computers and electric home appliances have advanced in pursuit of high-density and high-speed access. In particular, there has been developed next generation high-density discs of 23 GB capacity using a blue laser.

In order to improve the recording capacity, the development of a disc structure having a plurality of recording layers is in progress. Also, in view of a next generation high-density writable and rewritable disc, there is a need for a user to be able to effectively protect data recorded on a plurality of recording layers and in recordable zones in each of the plurality of recording layers from overwriting.

### SUMMARY OF THE INVENTION

Accordingly, the present invention provides a multi-layer recording medium, which stores write protection information for protecting the multi-layer recording medium from overwriting, a method of recording write protection information, and a write protection method thereof.

The present invention also provides a multi-layer recording medium capable of selectively protecting every recording layer from overwriting, and a recording method and a write protection method thereof.

The present invention also provides a multi-layer recording medium capable of selectively protecting every recording zone from overwriting, and a recording method and a write protection method thereof.

Additional aspects and advantages of the invention will be set forth in part in the description which follows and, in part, will be obvious from the description, or may be learned by practice of the invention.

According to an aspect of the present invention, a multi-layer optical recording medium includes writable or rewritable recording layers, where each of the layers includes a lead-in zone, a lead-out zone, and a data zone, the multi-layer optical recording medium stores write protection information for selectively protecting data recorded on the multi-layer recording medium from overwriting.

According to an aspect of the invention, the write protection information selectively protects each of the plurality of writable or rewritable recording layers or every recording zone.

According to another aspect of the present invention, a method of recording data on a multi-layer optical recording medium having a plurality of writable or rewritable recording layers, where each of the layers includes a lead-in zone, a lead-out zone, and a data zone, where write protection information for selectively protecting data recorded on the multi-layer recording medium from overwriting is recorded, the method includes recording write protection information for selectively protecting each of the plurality of writable or rewritable recording layers and recording write protection information for selectively protecting each recording zone in each of the plurality of writable or rewritable recording layers.

According to still another aspect of the present invention, a write protection method of protecting data recorded on a multi-layer optical recording medium including a plurality of writable or rewritable recording layers, where each of the layers has a lead-in zone, a lead-out zone, and a data zone, from overwriting, the method including checking write protection information recorded on the multi-layer optical recording medium, and selectively preventing the data from being recorded on the multi-layer optical recording medium according to the checked write protection information.

According to an aspect of the invention, the selectively preventing data from being recorded on the multi-layer optical recording medium includes preventing the data from being recorded on each of the writable or rewritable recording layers according to the write protection information and/or in each recording zone according to the write protection information.

The write protection information recorded on the multi-layer optical recording medium and a write protection state of a case including the multi-layer optical recording medium are checked. If the write protection information is not consistent with the write protection state of the case, a user is informed of the inconsistency.

### BRIEF DESCRIPTION OF THE DRAWINGS

The above and/or other features and advantages of the present invention will become more apparent and more readily appreciated by describing in detail exemplary embodiments thereof with reference to the accompanying drawings of which:

FIG. 1 shows a recording medium having a multi-layer structure according to an embodiment of the present invention;

FIG. 2 shows the multi-layer structure of the recording medium shown in FIG. 1;

FIG. 3 shows the structure of a zone in which write protection information is stored according to an embodiment of the present invention;

FIG. 4 shows the data structure of the write protection information shown in FIG. 3;

FIG. 5 shows a recording medium in which only a user data zone of a layer 1 is protected from recording by write protection information according to an embodiment of the present invention; and

FIG. 6. shows an embodiment of a recording and/or reproducing apparatus for use with the recording medium of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

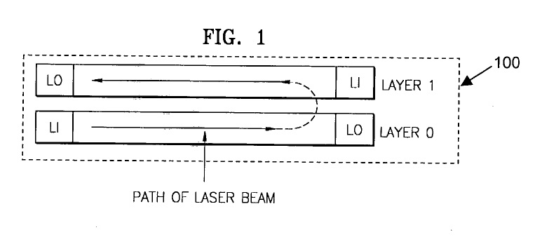

For high-density recording, a next generation high-density disc may include a plurality of recording layers or a single layer. However, in the example of the present invention shown in FIG. 1, the next generation high-density disc includes two representative layers: a layer 0 and a layer 1. The layer 0 includes a lead-in zone LI formed at the inner perimeter of the layer 0, a lead-out zone LO formed at the outer perimeter of the layer 0, and a user data zone formed between the lead-in zone LI and the lead-out zone LO. The layer 1, considering a recording direction according to a laser beam, includes a lead-out zone LO formed at the inner perimeter of the layer 1, a lead-in zone LI formed at the outer perimeter of the layer 1, and a user data zone formed between the lead-in zone LI and the lead-out zone LO of layer 1. Thus, assuming that data is recorded starting from the user data zone after the lead-in zone LI at the inner perimeter of the layer 0, after the recording of data in the user data zone in the layer 0 is finished and additional recording is to be performed, the data is recorded starting from the user data zone in front of the lead-in zone LI of layer 1.

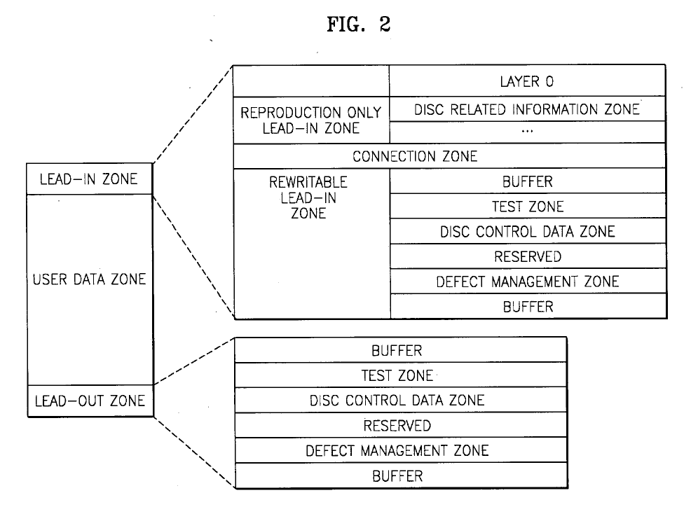

FIG. 2 illustrates the structure of the recording medium shown in FIG. 1 according to an embodiment of the present invention. Here, only the layer 0 is shown, but the layer 1 also has the same structure as the layer 0. Referring to FIG. 2, the layer 0 is divided into three sections according to its function: a lead-in zone, a user data zone, and a lead-out zone.

The lead-in zone may be divided into an unrecordable zone and a recordable zone according to its physical characteristics. In particular, the lead-in zone has a reproduction only lead-in zone in which recording is impossible, a rewritable lead-in zone, and a connection zone of a wobble or mirror form therebetween. The reproduction only lead-in zone may exist in a wobble form such as a groove track of a high frequency, or in a pit form. The reproduction only lead-in zone has a disc-related information zone in which a disc type, a disc size, a version number, recording conditions, and so forth can be stored, and a zone in which other pieces of information can be stored. The rewritable lead-in zone includes a buffer, a test zone for optimal power control (OPC) fit for the recording conditions, a disc control data zone, a reserved zone, a defect management zone, and a buffer. The user data zone and the lead-out zone have rewritable zones. The lead-out zone includes a buffer, a test zone, a disc control data zone, a reserved zone, a defect management zone, and a buffer.

Here, the disc control data zone, the defect management zone, and the reserved zone in each of the rewritable lead-in zone and the lead-out zone are each shown as one zone in FIG. 2. However, preferably, there are a plurality of zones that are physically separated from each other in order to guard against being rendered unusable due to errors on the disc.

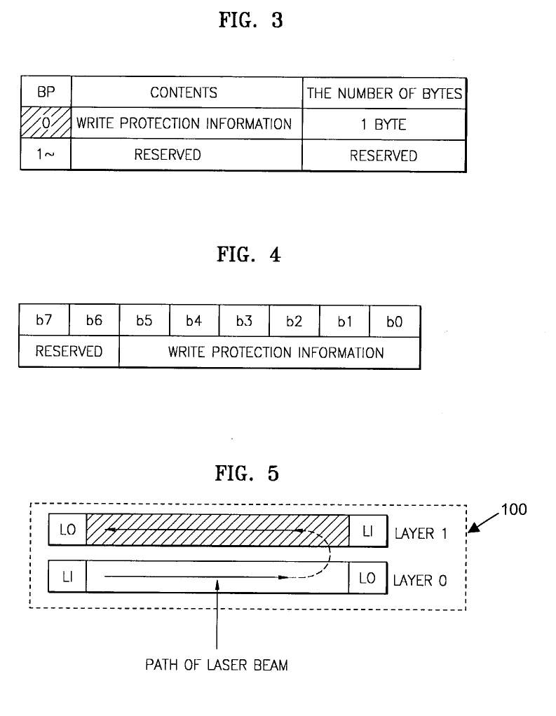

FIG. 3 illustrates the structure of a zone in which write protection information is stored according to an embodiment of the present invention. The write protection information may be recorded in any of the recordable zones except the user data zone shown in FIG. 2. For instance, the write protection information is stored in the disc control data zone or the reserved zone in the rewritable lead-in zone of the lead-in zone, or the disc control data zone or the reserved zone of the lead-out zone.

Referring to FIG. 3, 1-byte write protection information is stored in a first byte (BPO) of the disc control data zone or the reserved zone, and the remaining bytes are reserved. For the safety and reliability of information, it is preferable, but not necessary that the write protection information is recorded multiple times on a disc. The write protection information may be recorded at either the inner or outer perimeter of the disc, but preferably, is recorded at both the inner and outer perimeters of the disc. Thus, the write protection formation is recorded in the disc control data zones or the reserved zones in the rewritable lead-in zone and the lead-out zone. In a case where a plurality of disc control data zones or reserved zones are physically separated from each other in each of the rewritable lead-in zone and the lead-out zone, it is preferable that the same write protection information is recorded multiple times. Here, the write protection information is recorded multiple times because zones in which the write protection information is recorded may not be used or data can be only read from and not recorded in the zones due to errors generated in the zones. Thus, the write protection information may be incorrectly read and the disc may operate abnormally so as to not permanently record data thereon and allow accidental overwriting.

FIG. 4 illustrates the data structure of the 1-byte write protection information shown in FIG. 3. Write protection information is recorded, according to an aspect of the invention, in a first byte of a disc control data zone or a reserved zone ( i.e., in a 0-btye position). However, it is understood that other locations could be used or later developed. The 1-byte write protection information is defined as follows.

bits b7 to b6: these bits are Reserved and are set to 00

bits b5 to b0: specify the write protection information

b5, b3, and b1 specify write protection on the entire

disc (layers), layer 0, and layer 1, respectively.

0b: Not write protected.

1b: Write protected.

b4, b2, and b0 specify write protection on a specific area

0b: Every area is write protected.

1b: User data area is write protected.

In other words, according to the above embodiment, bit positions 7 b7 and 6 b6 of the write protection information are reserved and may be set to “00”. Bit positions 5 b5, 3 b3, and 1 b1 indicate whether the entire disc (layers), a layer 0, and a layer 1, respectively, are write protected so as to selectively protect all or individual recording layers from recording. If each bit position value is “0b”, writing is not protected. If each bit position value is “1b”, writing is prevented. Bit positions 4 b4, 2 b2, and 0 b0 indicate whether specific zones are write protected and may selectively protect zones of each layer from recording. If each bit position value is “0b”, writing is not protected. If each bit position value is “1b”, writing is protected.

While two recording layers, (i.e., a layer 0 and a layer 1), and write protection information for protecting all zones or user data zones from recording are described herein, it is understood that additional recording layers may be further included and that the write protection information for selectively protecting recording layers and minute zones from recording may be recorded thereon.

FIG. 5 illustrates a recording medium in which only a user data zone of a layer 1 is write protected by write protection information according to another embodiment of the present invention. 1-byte write protection information is recorded as “00000011b” in a disc control data zone or a reserved zone. Since bit position 1 (b1) is “1b”, bit position 1 (b1) indicates that the layer 1 is write protected. If bit position 0 (b0) is “1b”, bit position 0 (b0) indicates that only the user data zone is write protected.

Referring to FIG. 5, let us assume that data is recorded starting from the user data zone after a lead-in zone LI at the inner perimeter of a layer 0 by a laser beam. Then, after recording data in the user data zone in the layer 0, even if recording is desired to continue, a user data zone (marked with slanted lines) before a lead-in zone LI at the outer perimeter of the layer 1 is write protected by write protection information stored in the disc control data zone or the reserved zone. Therefore, the user data zone is write protected.

Accordingly, a write protection method according to the present invention includes checking write protection information recorded on a multi-layer recording medium and selectively preventing data from being recorded on the multi-layer recording medium according to the checked write protection information. It is understood that the method being performed could be performed using a controller to control an optical pickup for use in recording and/or reproducing data with respect to the disc shown in FIG. 1 using the laser beam. The controller could be implemented as a computer, either a general purpose of a special purpose computer, which implements the method as computer software stored on a computer readable medium.

A disc is sometimes in a cartridge state in which the disc is mounted in a case. However, a bare disc is also often used. When a disc in a case is used, data recorded by a user can be protected from overwriting using a write protection hole formed in the case. Specifically, in order to write protect the disc within the case, the write protection hole is switched from a closed state indicating the “disc is not write protected” to an open state indicating the “disc is write protected”, so that a recording apparatus does not perform a writing operation on a write protected disc. However, when a bare disc state without a case is used, the disc itself must protect data recorded by the user from overwriting. To this end, the above-described write protection information according to the present invention is proposed. When a bare disc is put into a case in which a write protection hole is set to a recordable state so that the bare disc is used in a cartridge or a disc is put into a case in which a write protection hole is set to a write protection sate, write protection information recorded on the disc may be inconsistent with the state of the write protection hole of the case so as to cause a conflict.

In case of conflict between the write protection states indicated by the case and the bare disc, if either the disc or the case is write protected, a user receives a warning message providing an opportunity to check the states of the disc and the case, and the disc is preferably treated as being write protected. This is because it is safer to not record data until the contents of the already recorded data are checked one more time, rather than risking the possibility of overwriting data by mistake. It is understood that the recording and/or reproducing apparatus can implement the warning message using a display connected to or controlled by the apparatus, using audible warnings, light indicators, and other similar mechanisms by which a user is informed.

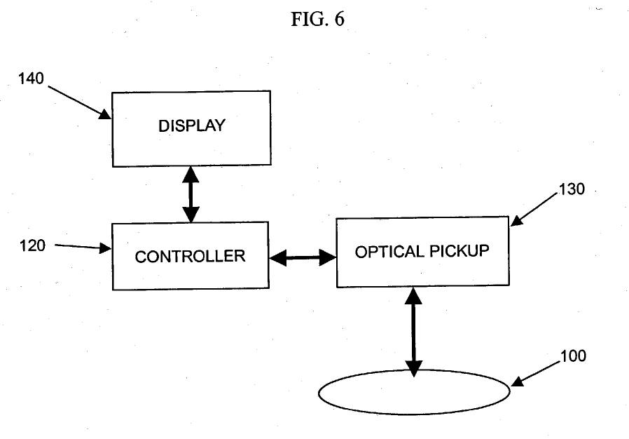

FIG. 6 shows a recording and/or reproducing apparatus according to an embodiment of the invention. A controller 120 controls an optical pickup 130 to record and/or reproduce data with respect to the disc 100. The optical pickup 130 has a light source to produce the laser beam. A display 140 is controllable by the controller 120 so as to display messages, such as a warning message.

As described above, according to the present invention, data recorded on a disc can be effectively protected from overwriting by recording write protection information for selectively protecting every recording layer and/or every recording zone of a multi-layer recording medium from overwriting.

Also, when only one of a case and a disc indicates that the disc is write protected, a user can be informed of the write protection state and thus have an opportunity to check the states of the disc and the case to resolve the conflict. As a result, data recorded on the disc can be stably protected.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A multi-layer optical recording medium comprising:
a plurality of recording layers, each layer being one of writable and rewritable and including a lead-in zone, a lead-out zone, and a data zone usable to store data and disposed between the lead-in and lead-out zones; and
write protection information stored on one of the layers for selectively protecting the data recorded on any of the layers of the multi-layer recording medium from being overwritten by new data.

2. The multi-layer optical recording medium of claim 1, wherein the write protection information selectively protects each corresponding recording layer, individually.

3. The multi-layer optical recording medium of claim 1, wherein the layers include recording zones, and the write protection information selectively protects each of the recording zones.

4. The multi-layer optical recording medium of claim 1, further comprising recordable zones, wherein the write protection information is recorded in the recordable zones and are not recorded in the data zone.

5. The multi-layer optical recording medium of claim 1, wherein the write protection information is recorded multiple times in different locations on the layers.

6. The multi-layer optical recording medium of claim 1, wherein the write protection information is recorded in inner and/or outer recordable zones.

7. The multi-layer optical recording medium of claim 1, wherein one of the lead-in and lead-out zones includes a control data zone in which the write protection information is recorded.

8. The multi-layer optical recording medium of claim 7, wherein the control data zone includes disc control zones that are physically separated from each other, and the write protection information is recorded as one or more pieces of identical information that is repeated in a plurality of the disc control data zones.

9. The multi-layer optical recording medium of claim 1, wherein one of the lead-in and lead-out zones includes a reserved zone and the write protection information is recorded in the reserved zone.

10. The multi-layer optical recording medium of claim 9, wherein the write protection information is recorded as one or more pieces of identical information that is repeated in a plurality of reserved zones that are physically separated from each other in the lead-in zone and/or the lead-out zone.

11. The multi-layer optical recording medium of claim 1, wherein the write protection information comprises information which indicates a write protection status differentiated between one of all recording layers being write protected, and one of the recording layers is write protected without indicating a write protection status of another one of the recording layers.

12. The multi-layer optical recording medium of claim 1, wherein the write protection information comprises information which indicates a write protection status differentiated between all recording layers being write protected and only the data zone of one of the recording layers is write protected.

13. The multi-layer optical recording medium of claim 1, further comprising a case in which a bare medium including the recording layers is stored and which includes a sensor hole for write protection.

14. The multi-layer optical recording medium of claim 1, wherein the multi-layer optical recording medium is a bare disc that is not mounted in a cartridge.

15. A method of recording data on a multi-layer optical recording medium having a plurality of writable or rewritable recording layers, where each of the layers includes a lead-in zone, a lead-out zone, and a data zone usable to store data and disposed between the lead-in and lead-out zones, the method comprising:
recording write protection information for selectively protecting the data recorded on one of the layers of the multi-layer recording medium from being overwritten by new data.

16. The method of claim 15, wherein the recording the write protection information comprises recording write protection information which indicates a write protection status of each corresponding recording layer, individually.

17. The method of claim 15, wherein the recording the write protection information comprises recording write protection information which indicates a write protection status of corresponding ones of recording zones of the recording layers without indicating a write protection status of other ones of the recording zones.

18. The method of claim 15, wherein the recording the write protection information comprises recording the write protection information in any recordable zone except the data zones of the recording layers.

19. The method of claim 15, further comprising again recording the write protection information on one of the recording layers.

20. The method of claim 15, wherein the recording the write protection information comprises recording the write protection information in inner and/or outer recordable zones of the recording layers.

21. The method of claim 15, wherein the recording the write protection information comprises recording the write protection information in a control data zone in one of the lead-in zone and the lead-out zone of one of the recording layers.

22. The method of claim 21, wherein the control zone comprises disc control zones, and the write protection information is recorded as one or more pieces of identical information that is repeated in a plurality of disc control data zones that are physically separated from each other.

23. The method of claim 15, wherein the recording the write protection information comprises recording the write protection information in a reserved zone in one of the lead-in zone and the lead-out zone.

24. The method of claim 23, wherein the reserved zone comprises multiple reserved sub-zones, and the recording the write protection information comprises recording the write protection information as one or more pieces of identical information that is repeated in a plurality of the reserved sub-zones that are physically separated from each other.

25. The method of claim 15, wherein the write protection information comprises information which indicates a write protection status differentiated between all of the recording layers and which of the desired recording layers are individually write protected.

26. The method of claim 15, wherein the write protection information comprises information which indicates a write protection status differentiated between all of the recording layers and of only the data zone of one of the recording layers.

27. A write protection method of protecting data recorded on a multi-layer optical recording medium including a plurality of writable or rewritable recording layers, each of the recording having a lead-in zone, a lead-out zone, and a data zone including the data and disposed between the lead-in and lead-out zones, from being overwritten by new data, the method comprising:
checking write protection information recorded on one of the recording layers of the multi-layer optical recording medium; and
selectively preventing the new data from being recorded on one of the recording layers according to the checked write protection information checked in the checking the write protection information.

28. The writing protection method of claim 27, wherein the selectively preventing the new data from being recorded comprises:
selectively preventing the new data from being recorded on each of the recording layers according to the write protection information.

29. The write protection method of claim 27, wherein the selectively preventing the new data from being recorded further comprises:
selectively preventing the new data from being recorded in each recording zone according to the write protection information.

30. The write protection method of claim 27, further comprising:
checking a write protection state of a case including the multi-layer optical recording medium; and
if the checked write protection information indicated by the optical recording medium is not consistent with the write protection state of the case, informing a user of the inconsistency.

31. The write protection method of claim 30, further comprising, if the checked write protection information indicated by the optical recording medium is not consistent with the write protection state of the case, protecting the multi-layer optical recording medium from recording.

32. The write protection method of claim 27, wherein the write protection information indicates that one of the recording layers is write protected and another of the recording layers is not write protected, and the method further comprises, according to the checked write protection information, recording the new data on the another recording layer without recording on the one recording layer.

33. The write protection method of claim 27, wherein if the write protection information indicates that one of the recording layers is write protected, the method further comprising checking the write protection information to determine if another of the recording layers is write protected, and, according to the checked write protection information, recording the new data on the another recording layer if the checked write protection information indicates that the another recording layer is not write protected.

34. The write protection method of claim 27, wherein the write protection information indicates that one of the data zones is write protected and another one of the data zones is not write protected, and the method further comprises, according to the checked write protection information, recording the new data on the another data zone without recording on the one data zone.

35. The multi-layer optical recording medium of claim 1, wherein the write protection information comprises information which indicates a write protection status of all recording layers, a write protection status of one of the recording layers without indicating the write protection status of another of the recording layers, and a write protection status of the another of the recording layers without indicating the write protection status of the one recording layer.

36. The multi-layer optical recording medium of claim 35, wherein the write protection information further comprises information which indicates the write protection status of one of the data zones as compared to another zone of the recording medium.

37. A recording and/or reproducing apparatus for recording and/or reproducing data with respect to an information recording medium having a recording layer with a lead-in zone, a lead-out zone, and a data zone usable to store the data and disposed between the lead-in and lead-out zones, the apparatus comprising:
an optical pickup to transfer the data between the information recording medium and the apparatus; and
a controller to control the optical pickup to record the data on the information recording medium, and to generate and record write protection information for selectively protecting the data recorded on the recording layer from being overwritten by new data.

38. The recording and/or reproducing apparatus of claim 37, wherein:
the information recording medium includes a plurality of recording layers, each recording layer including a corresponding lead-in zone, a corresponding lead-out zone, and a corresponding data zone usable to store the data on the recording layer, and
the write protection information comprises write protection information which indicates a write protection status differentiated between write protection statuses of each corresponding recording layer.

39. The recording and/or reproducing apparatus of claim 37, wherein:
the information recording medium includes a plurality of recording layers, each recording layer including a corresponding lead-in zone, a corresponding lead-out zone, and a corresponding data zone usable to store the data on the recording layer, and
the write protection information comprises write protection information which indicates a write protection status differentiated between corresponding data zones in each of the recording layers.

40. The recording and/or reproducing apparatus of claim 38, wherein the controller records the write protection information in any recordable zone except the data zones of the recording layers.

41. The recording and/or reproducing apparatus of claim 40, wherein the controller records the write protection information in at least two of the lead-in and lead-out zones of the recording layers.

42. The recording and/or reproducing apparatus of claim 37, wherein, when the controller records the new data on the recording layer, the controller further checks the write protection information recorded on the recording layer and selectively prevents the new data from being recorded on the recording layer according to the checked write protection information.

43. The recording and/or reproducing apparatus of claim 42, wherein:
the information recording medium includes a plurality of recording layers, each recording layer including a corresponding lead-in zone, a corresponding lead-out zone, and a corresponding data zone usable to store data on the recording layer, and
the controller selectively prevents the new data from being recorded in each write-protected data zone according to the write protection information.

44. The recording and/or reproducing apparatus of claim 42, wherein:
the information recording medium includes a plurality of recording layers, each recording layer including a corresponding lead-in zone, a corresponding lead-out zone, and a corresponding data zone usable to store the data on the recording layer,
the write protection information indicates that one of the recording layers is write protected and another of the recording layers is not write protected, and
the controller, according to the checked write protection information, records the new data on the another recording layer without recording on the one write-protected recording layer.

45. The recording and/or reproducing apparatus of claim 42, wherein:
the information recording medium includes a plurality of recording layers, each recording layer including a corresponding lead-in zone, a corresponding lead-out zone, and a corresponding data zone usable to store the data on the recording layer,
the write protection information indicates that one of the data zones is write protected and another one of the data zones is not write protected, and
the controller, according to the checked write protection information, records the new data on the another data zone without recording on the one write-protected data zone.

46. The recording and/or reproducing apparatus of claim 37, wherein:
the information recording medium includes a plurality of recording layers; and
the write protection information comprises information which indicates a write protection status which differentiates between statuses of all recording layers, a write protection status of one of the recording layers without indicating the write protection status of another of the recording layers, and a write protection status of the another of the recording layers without indicating a write protection status of the one recording layer.

47. The recording and/or reproducing apparatus of claim 46, wherein:
each recording layer includes a corresponding lead-in zone, a corresponding lead-out zone, and a corresponding data zone usable to store data on the recording layer; and
the write protection information comprises information which indicates the write protection status of one of the data zones as compared to another zone of the recording medium.

48. A computer readable medium encoded with processing instructions for implementing a method of recording data on a multi-layer optical recording medium having a plurality of writable or rewritable recording layers, where each of the recordable layers includes a lead-in zone, a lead-out zone, and a data zone usable to store the data and disposed between the lead-in and lead-out zones, performed by a computer, the method comprising
recording write protection information for selectively protecting the data recorded on one of the layers of the multi-layer recording medium from being overwritten by new data.

49. The computer readable medium of claim 48, wherein the recording the write protection information comprises recording write protection information differentiates between the recording layers so as to individually indicate write protection statuses of each corresponding recording layer.

50. The computer readable medium of claim 48, wherein the recording the write protection information comprises recording write protection information which indicates a write protection status differentiated between corresponding ones of recording zones of the recording layers without indicating the write protection status for protecting other ones of the recording zones.

51. The computer readable medium of claim 48, wherein the recording the write protection information comprises recording the write protection information in any recordable zone except the data zones of the recording layers.

52. The computer readable medium of claim 48, wherein the write protection information is recorded as one or more pieces of identical information that is repeated in a plurality of control data zones that are physically separated from each other.

53. The computer readable medium of claim 48, wherein the write protection information comprises information capable of indicating a write protection status of all of the recording layers, which of the desired recording layers are individually write protected, and which of the desired recording layers are not write protected.

54. The computer readable medium of claim 48, wherein the write protection information comprises information capable of indicating a write protection status of which one of the data zones is write protected, and of which other one of the data zones is not write protected.

55. The computer readable medium of claim 48, wherein, prior to recording the new data on the optical recording medium, the method further comprises:
checking the write protection information recorded on one of the recording layers of the multi-layer optical recording medium; and
selectively preventing the new data from being recorded on one of the recording layers according to the checked write protection information.

56. The computer readable medium of claim 55, wherein the selectively preventing the new data from being recorded comprises selectively preventing the new data from being recorded on each of the recording layers according to the write protection information.

57. The computer readable medium of claim 55, wherein the selectively preventing the new data from being recorded further comprises selectively preventing the new data from being recorded in each recording zone according to the write protection information.

58. The computer readable medium of claim 55, wherein the write protection information indicates that one of the recording layers is write protected and another of the recording layers is not write protected, and the method further comprises, according to the checked write protection information, recording the new data on the another recording layer without recording on the one recording layer.

59. The computer readable medium of claim 55, wherein if the write protection information indicates that one of the recording layers is write protected, the method further comprises checking the write protection information to determine if another of the recording layers is write protected, and, according to the checked write protection information, recording the new data on the another recording layer if the checked write protection information indicates that the another recording layer is not write protected.

60. The computer readable medium of claim 55, wherein the write protection information indicates that one of the data zones is write protected and another one of the data zones is not write protected, and the method further comprises, according to the checked write protection information, recording the new data on the another data zone without recording on the one data zone.
